(19) United States
(12) Patent Application Publication
(10) Pub. No.: US 2025/0321614 A1
(43) Pub. Date: Oct. 16, 2025

(54) DISPLAY DEVICE HAVING VARIABLE SCREEN SIZE

(71) Applicant: AUFLEX CO., LTD., Hwaseong-si (KR)

(72) Inventor: Hyun Min PARK, Suwon-si (KR)

(21) Appl. No.: 18/712,852

(22) PCT Filed: Nov. 24, 2022
(86) PCT No.: PCT/KR2022/018775

§ 371 Date: Aug. 1, 2024

(30) Foreign Application Priority Data
Nov. 24, 2021 (KR) 10-2021-0163850

(51) Int. Cl. G06F 1/16

(52) U.S. Cl. CPC G06F 1/1624; G06F 1/1652

(57) ABSTRACT

Provided is a display device having variable screen size. In the display device having variable screen size, a modified X bar including main bars and sub bars is provided in a rollable display device in which a display screen is widened or narrowed while rolling such that a wide display screen is realized.

### TECHNICAL FIELD

The present invention relates to a display device having variable screen size and more particularly to a display device having variable screen size in which a modified X bar including main bars and sub bars is provided in a rollable display device in which a display screen is widened or narrowed while rolling such that a wide display screen is realized.

### BACKGROUND ART

Mobile communication terminals are configured to perform various functions. Examples of the functions include a data and speech communication function, a function of capturing a still image or a moving image using a camera, a speech storing function, a function of reproducing a music file using a speaker system, and a function of displaying a still image or a moving image (a video).

Some mobile communication terminals have additional functions for playing games, and some mobile communication terminals are embodied as multimedia devices. Recent mobile communication terminals can also receive broadcast or multicast signals and reproduce a video or a television program.

Researches for supporting and improving other functions of mobile communication terminals in addition to the above-mentioned functions have been carried out. These researches include modification and improvement of structural constituents of the mobile communication terminals and addition and improvement of software or hardware.

In general, a display module of a mobile communication terminal displays information which is processed by the mobile communication terminal. For example, when the mobile communication terminal is in a call mode, the display module displays a user interface (UI) or a graphic user interface (GUI) associated with a call.

When the mobile communication terminal is in a video call mode or an image capturing mode, the display module displays a captured or/and received image, a UI, or a GUI. The display module includes a liquid crystal display, a thin-film transistor liquid crystal display, an organic light emitting diode, a flexible display, or a 3D display.

A flexible display (or a flexible LCD) has been regularly researched with its merit of deformability. However, it takes much time to use a rolled display like a paper roll as shown in science-fiction movie.

Therefore, transitional forms of flexible displays will be many used until the flexible displays are regularly used with sufficient development thereof, and these transitional forms will be similar to current structures of communication terminals. Accordingly, there is necessity for description of usage and protection of flexible displays when such flexible displays are used in mobile communication terminals.

An example of a hinge structure for a mobile communication terminal having a flexible display panel installed therein is disclosed in Korean Patent Application Laid-open No. 10-2015-0096827 (Title of the Invention: HINGE STRUCTURE AND FOLDABLE DISPLAY DEVICE INCLUDING THE SAME).

### SUMMARY OF THE INVENTION

### Technical Problem

The present invention provides a display device having variable screen size in which a modified X bar including main bars and sub bars is provided in a rollable display device in which a display screen is widened or narrowed while rolling such that a wide display screen is realized.

### Solution to Problem

In order to achieve the above-mentioned objective, there is provided a display device having variable screen size including: a fixed frame; a sliding frame that slides along the fixed frame; and a sliding controller connected to the fixed frame and the sliding frame and configured to control a distance by which the sliding frame slides along the fixed frame,

The sliding controller includes: an X bar in which centers of a pair of main bars are rotatably connected; and sub bars rotatably connected to ends on one side of the main bars to form a second rotation point, ends on the other side of the sub bars being rotatably connected to a central bar of the fixed frame to form a third rotation point, each sub bar having a length of half the length of the main bars.

The sliding frame includes a sliding bar sliding in the sliding frame and a fixed bar fixed to the sliding frame.

Ends on the other side of the main bars of the sliding controller are connected to the sliding bar, and a center part between the first rotation point at which the main bars are connected to each other in an X-shape and the second rotation point is connected to the fixed bar.

The sliding controller controls moving distances and speeds of the sliding frame moving along both side rails of the fixed frame and the sliding bar moving along the sliding frame together.

Elastic devices provided in the sub bars in a state in which the pair of sub bars are connected to the central bar of the fixed frame and are connected to each other at the third rotation point apply an elastic force to the sub bars in opposite directions.

A panel holder for preventing sagging of a flexible display panel is installed between the sliding frame and the fixed frame.

According to another embodiment, there is provided a display device having variable screen size including: a pair of fixed frames; a central bar configured to fixedly connect the pair of fixed frames; and a pair of sliding frames that slide along the fixed frames.

The display device further includes a bidirectional sliding controller connected to the fixed frames and the sliding frames and configured to control a distance by which the sliding frames slide along the fixed frame with respect to a center part of the central bar. The bidirectional sliding controller includes center bars of which centers are connected to the central bar in an X-shape, and ends on one side of the center bars connected in an X-shape are connected to the main bars connected in an X-shape to form a second rotation point.

The sliding frame includes a sliding bar sliding in the sliding frame and a fixed bar fixed to the sliding frame, and ends on the other side of the main bars of the bidirectional sliding controller are connected to the sliding bar.

A center part between the first rotation point at which the main bars are connected to each other in an X-shape and the second rotation point is connected to the fixed bar.

The bidirectional sliding controller controls moving distances and speeds of the sliding frames moving along both side rails of the fixed frames and the sliding bars moving along the sliding frames together.

A center at which the pair of center bars are connected to each other is connected to the central bar of the fixed frame to form a third rotation point, and an elastic device is connected to the center bars such that an elastic force is applied to the center bars in opposite directions.

A panel holder for preventing sagging of a flexible display panel is installed between each sliding frame and the corresponding fixed frame.

### Advantageous Effects of Invention

With the display device having variable screen size according to the present invention, it is possible to realize a wide display screen by providing a modified X bar including main bars and sub bars in a rollable display device in which a display screen is widened or narrowed while rolling.

One X bar and sub bars with a length of half the length of the X bar are provided in the display device. Accordingly, it is possible to increase the screen size more than in a case in which a hinge includes one X bar, and it is possible to enhance reliability of products more than in a case in which a hinge includes two X bars. When a hinge includes two X bars, a display product may not bear the whole weight thereof, and a frame may be inclined. On the other hand, according to the present invention, it is possible to more widely utilize the display panel by using a hinge including one X bar and two half bars and to satisfactorily support an unfolded part even in a state in which the display product has been fully unfolded.

Since one X bar and two half bars are provided on each of the right and left sides of the central bar, it is possible to more widely utilize the display panel and to stably support the sliding frame on the fixed frame even in a state in which the display product has been fully unfolded.

### BRIEF DESCRIPTION OF DRAWINGS

FIG. 1 is a perspective view illustrating a state in which a sliding bar is being assembled into a sliding frame of a display device having variable screen size according to the present invention.

FIG. 2 is a perspective view illustrating a state in which the sliding frame is being coupled to a fixed frame according to the present invention.

FIG. 3 is a perspective view illustrating a state in which the sliding frame has been coupled to the fixed frame according to the present invention.

FIG. 4 is a perspective view illustrating a state in which a sliding controller for controlling movement of a sliding bar and a sliding frame is being installed according to the present invention.

FIG. 5 is a perspective view illustrating a state in which the sliding controller has been installed in the display device having variable screen size according to the present invention.

FIG. 6 is a plan view illustrating a state in which the sliding bar and the sliding frame have been fully folded with respect to a central bar of a fixed frame according to the present invention.

FIG. 7 is a plan view illustrating a state in which the sliding bar and the sliding frame have been unfolded far away from the central bar of the fixed frame according to the present invention.

FIG. 8 is a plan view illustrating a state in which the sliding bar and the sliding frame have been fully unfolded with respect to the central bar of the fixed frame according to the present invention.

FIG. 9 is a perspective view illustrating a state in which a flexible display has been installed to be connected to the sliding bar according to the present invention.

FIG. 10 is a perspective view illustrating a state in which a sliding controller according to another embodiment of the present invention has been installed.

FIG. 11 is a perspective view illustrating a state in which an elastic unit of a sliding controller according to another embodiment of the present invention is being assembled.

FIG. 12 is a partially enlarged view illustrating a state in which the elastic unit of the sliding controller according to another embodiment of the present invention is operating.

FIG. 13 is a perspective view illustrating a state in which a pair of panel holders are being installed in a front frame of the fixed frame according to the present invention.

FIG. 14 is a perspective view illustrating a state in which the panel holders are being installed in a panel holder connection part according to the present invention.

FIG. 15 is a perspective view illustrating a state in which the panel holder connection part is being fixed to the sliding frame according to the present invention.

FIG. 16 is a perspective view illustrating a state in which the panel holders have been installed in the panel holder connection part installed in the front frame of the fixed frame and the sliding frame according to the present invention.

FIG. 17 is a perspective view illustrating a state in which a pair of center bars of a bidirectional sliding controller are coupled according to the present invention.

FIG. 18 is a perspective view illustrating a state in which a bidirectional sliding controller for controlling movement of the sliding bars and the sliding frames installed on two sides is being installed according to the present invention.

FIG. 19 is a perspective view illustrating a state in which a flexible display panel has been installed in a state in which the bidirectional sliding controller has been assembled into the sliding bars and the sliding frames according to the present invention.

FIG. 20 is a perspective view illustrating a state in which a flexible display panel has been installed in a state in which the bidirectional sliding controller assembled into the sliding bars and the sliding frames has been fully folded according to the present invention.

FIG. 21 is a perspective view illustrating a state in which the flexible display panel has been connected to the fully folded bidirectional sliding controller illustrated in FIG. 20.

FIG. 22 is a perspective view illustrating a state in which a side surface corresponding to a bottom surface of the display device is being covered by covers in a state in which the flexible display panel has been connected to the fully folded bidirectional sliding controller of the display device according to the present invention.

FIG. 23 is a perspective view illustrating a state in which the bidirectional sliding controller exposed from the bottom surface of the display device having variable screen size is being covered by a cover according to the present invention.

FIG. 24 is a perspective view illustrating a state in which the bidirectional sliding controller exposed from the bottom surface of the display device having variable screen size has been covered by the cover according to the present invention.

### DESCRIPTION OF EMBODIMENTS

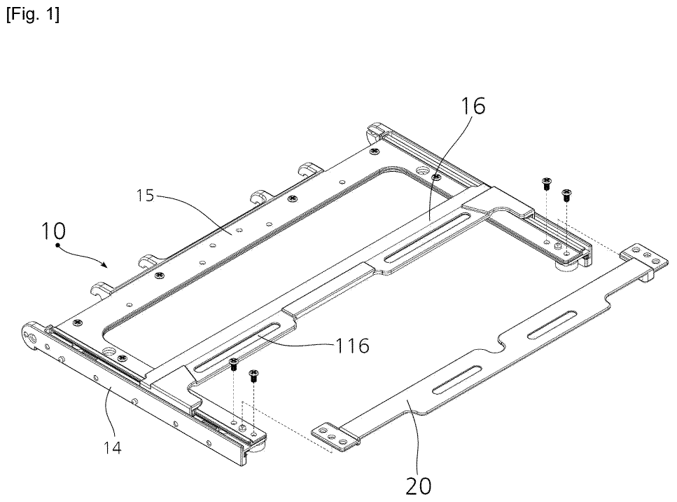

FIG. 1 is a perspective view illustrating a state in which a sliding bar is being assembled into a sliding frame of a display device having variable screen size according to the present invention.

Referring to FIG. 1, a display device having variable screen size according to the present invention includes a sliding frame 10 of a c-shape. A sliding bar 16 moving along both side surfaces of the sliding frame 10 and a fixed bar 20 fixed to the sliding frame 10 are installed in the sliding frame 10.

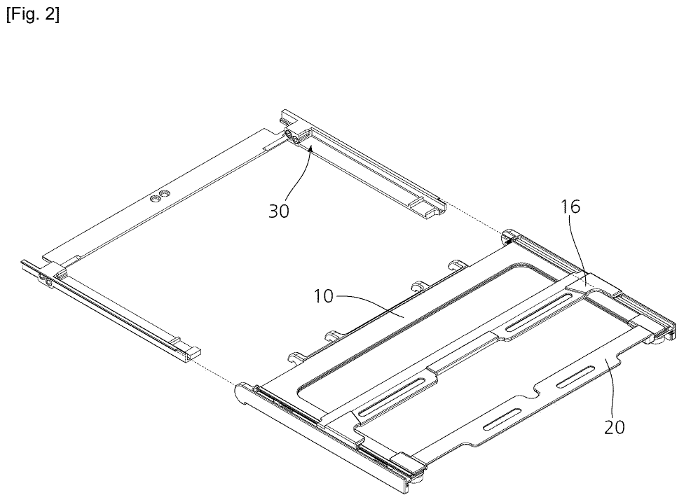

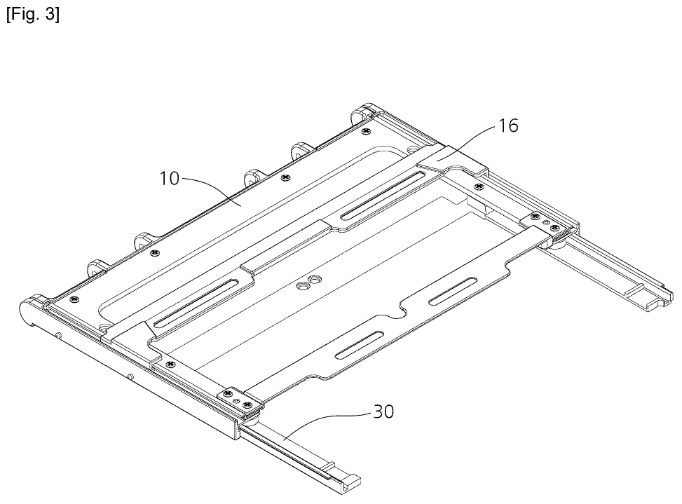

FIG. 2 is a perspective view illustrating a state in which the sliding frame is being coupled to the fixed frame according to the present invention. FIG. 3 is a perspective view illustrating a state in which the sliding frame has been coupled to the fixed frame according to the present invention.

Referring to FIGS. 2 and 3, both side parts of the sliding frame 10 are slidably inserted into both side parts of the fixed frame 30.

In the present invention, the sliding frame 10 is configured to slide along the fixed frame 30.

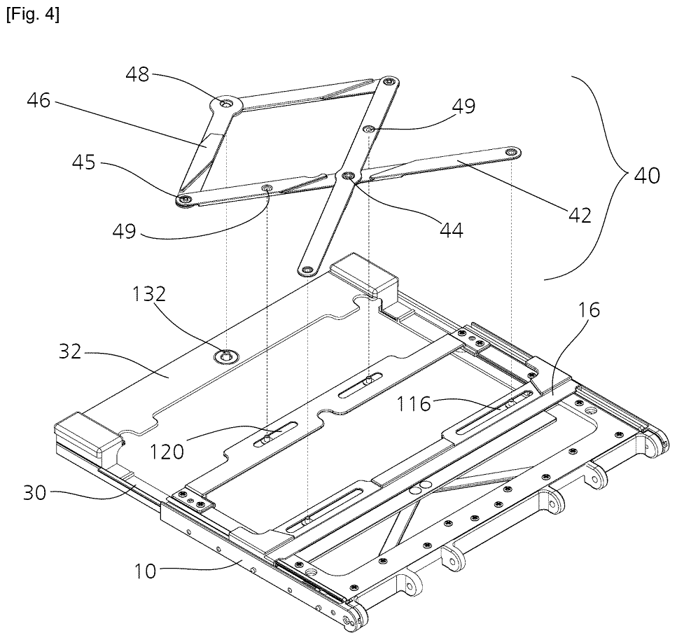

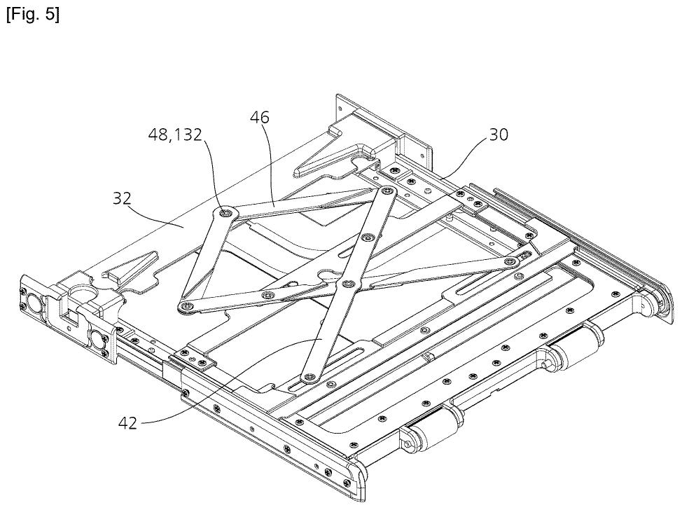

FIG. 4 is a perspective view illustrating a state in which a sliding controller for controlling movement of the sliding bar and the sliding frame is being installed according to the present invention. FIG. 5 is a perspective view illustrating a state in which the sliding controller has been installed in the display device having variable screen size according to the present invention.

Referring to FIGS. 4 and 5, in a state in which the sliding frame 10 has been slidably installed in both side rails of the fixed frame 30, the sliding controller 40 is installed to connect a central bar 32 of the fixed frame 30 to the fixed bar 20 and the sliding bar 16 of the sliding frame 10.

The sliding controller 40 controls moving distances and speeds of the sliding frame 10 moving along both side rails of the fixed frame 30 and the sliding bar 16 moving along both side rails of the sliding frame 10 together.

In the present invention, the central bar 32 is installed to connect ends of the side rails of the fixed frame 30.

The sliding controller 40 has a configuration in which center parts of two main bars 42 having the same length are rotatably connected in an X-shape (to form a first rotation point 44), ends on one side of a pair of sub bars 46 having half the length of the main bars 42 are rotatably connected to ends on one side of the main bars 42 (to form a second rotation point 45), and ends on the other side of the two sub bars 46 are rotatably connected to a central part of the central bar 32 (to form a third rotation point 48).

A first connection point 43 is formed at the other end of each of the main bars 42, the first connection points 43 are connected to rail grooves 116 including a groove in a longitudinal direction of the sliding bar 16, and the first connection points 43 of the main bars 42 are slidably along the rail grooves 116 of the sliding bar 16.

The first connection points 43 are connected to the rail grooves 116 of the sliding bar 16 using rivets or the like.

A second connection point 49 is formed between the first rotation point 44 and the second rotation point 45 in each main bar 42.

The second connection points 49 of the main bars 42 are connected to the fixed bar 20 of the sliding frame 10 via rail grooves 120 formed as grooves in a longitudinal direction of the fixed bar 20 and are slidable along the rail grooves 120.

The second connection points 49 and the rail grooves 120 are connected to each other using rivets or the like.

The third rotation point 48 at which a pair of sub bars 46 are rotatably connected to each other is rotatably connected to a central point 132 formed at the center of the central bar 32 of the fixed frame 30.

The first connection points 43 and the second connection points 49 of the main bars 42 are connected to the rail grooves 116 of the sliding bar 16 and the fixed bar 20 of the sliding frame 10, and thus moving distances per unit time of the sliding bar 16 and the sliding frame 10 with respect to the central point 132 of the fixed frame 30 are controlled by the sliding controller 40.

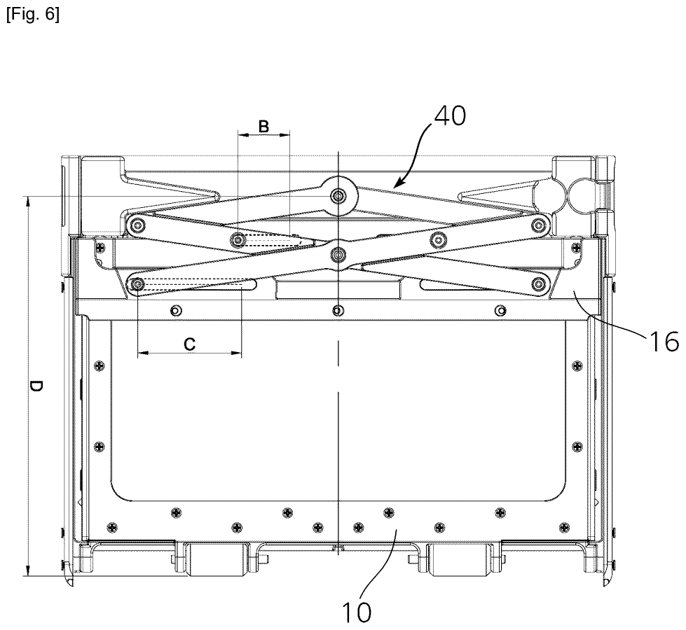

FIG. 6 is a plan view illustrating a state in which the sliding bar and the sliding frame have been fully folded with respect to the central bar of the fixed frame according to the present invention.

Referring to FIG. 6, with respect to the central bar 32 of the fixed frame 30, the sliding frame 10 is folded to the central bar 32, and the sliding bar 16 of the sliding frame 10 is also fully folded to the central bar 32.

In this case, the sliding controller 40 is also fully folded.

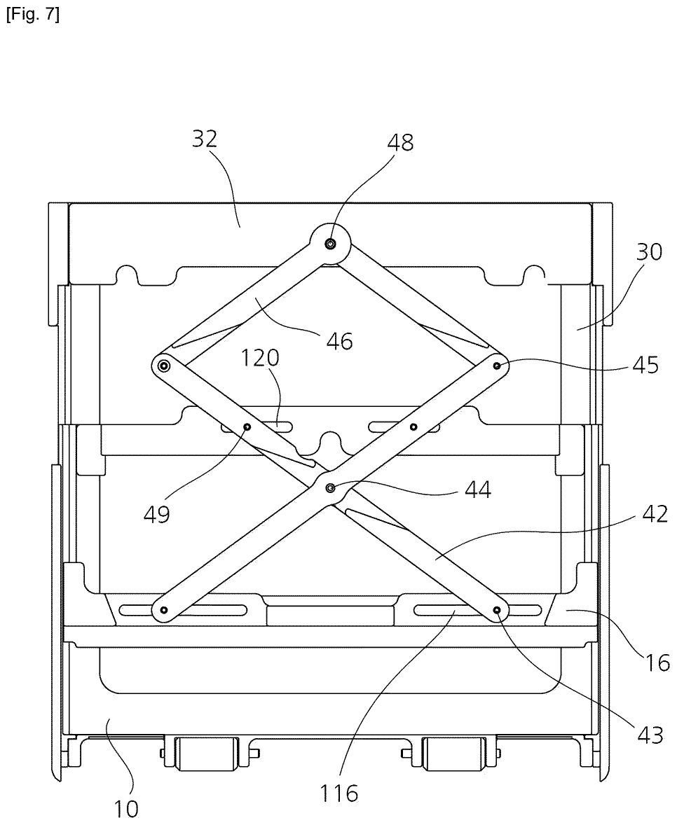

FIG. 7 is a plan view illustrating a state in which the sliding bar and the sliding frame have been unfolded far away from the central bar of the fixed frame according to the present invention.

Referring to FIG. 7, the sliding frame 10 slides along the fixed frame 30 to be far away from the central bar 32, and the sliding bar 16 slides and moves on the sliding frame 10 in the same direction as the direction in which the sliding frame 10 moves on the fixe frame 30.

A distance per unit time by which the sliding bar 16 moves on the sliding frame 10 is the same as a distance per unit time by which the sliding frame 10 moves on the fixed frame 30.

Accordingly, a distance per unit time by which the sliding bar 16 moves with respect to the central point 132 of the central bar 32 doubles a distance per unit time by which the fixed bar 20 of the sliding frame 10 moves.

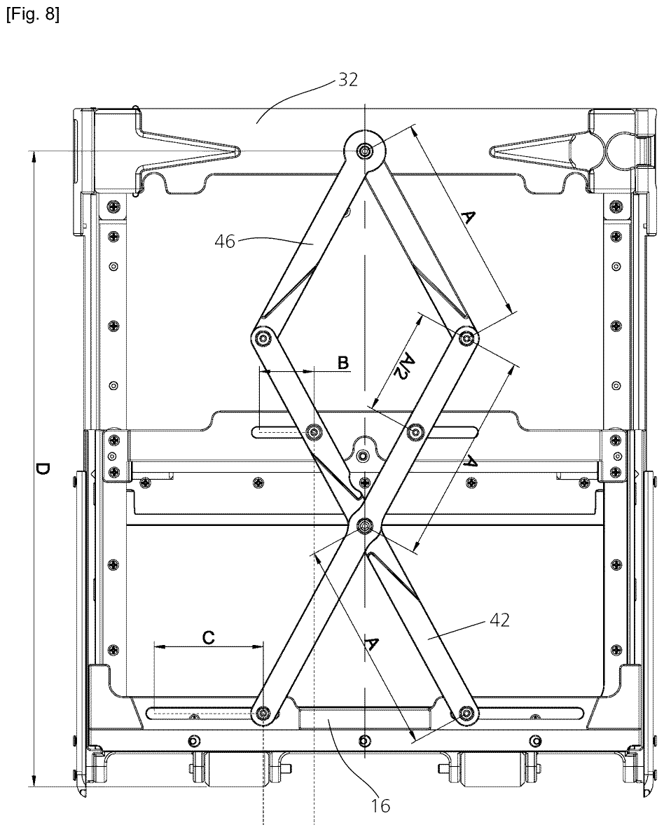

FIG. 8 is a plan view illustrating a state in which the sliding bar and the sliding frame have been fully unfolded with respect to the central bar of the fixed frame according to the present invention.

Referring to FIG. 8, when the sliding controller 40 is maximally unfolded with respect to the central point 132, the sliding bar 16 and the sliding frame 10 connected to the sliding controller 40 are maximally unfolded with respect to the central bar 32.

The display device having variable screen size according to the present invention is configured such that the flexible display panel is widely unfolded by the sliding controller 40 in which the longitudinal center parts of a pair of main bars 42 are rotatably connected to each other and sub bars 46 with half the length of the main bars 42 are rotatably connected to ends of the main bars 42.

FIG. 9 is a perspective view illustrating a state in which a flexible display has been installed to be connected to the sliding bar according to the present invention.

Referring to FIG. 9, a part with an invariable size of the flexible display panel 4 is fixed to a top surface of the display device having variable screen size according to the present invention.

An end of a part with a variable size of the flexible display panel 4 is connected to the sliding bar 16 which is located below the display device according to the present invention.

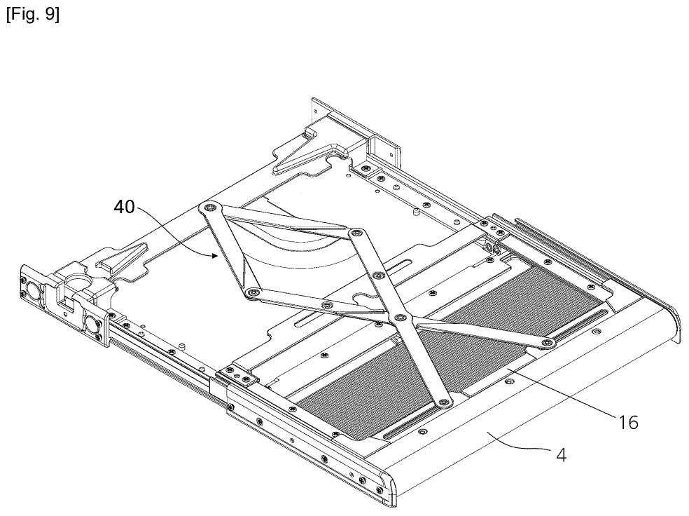

FIG. 10 is a perspective view illustrating a state in which a sliding controller according to another embodiment of the present invention has been installed.

Referring to FIG. 10, a sliding controller 140 according to another embodiment of the present invention is connected to the central bar 32 of the fixed frame 30 and the fixed bar 20 and the sliding bar 16 of the sliding frame 10.

An elastic unit 90 is provided in a part in which a pair of sub bars 146 and 147 are connected to the central point 132 of the central bar 32.

The elastic unit 90 according to the present invention serves to allow the sliding controller 140 to be unfolded or folded up to a predetermined distance (a threshold distance) by a user using an elastic force and to enable the sliding controller 140 to be automatically unfolded or folded using the elastic force over the threshold distance.

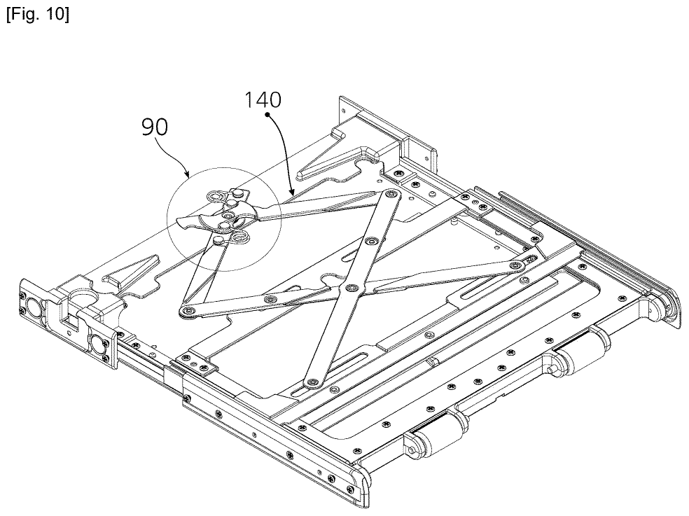

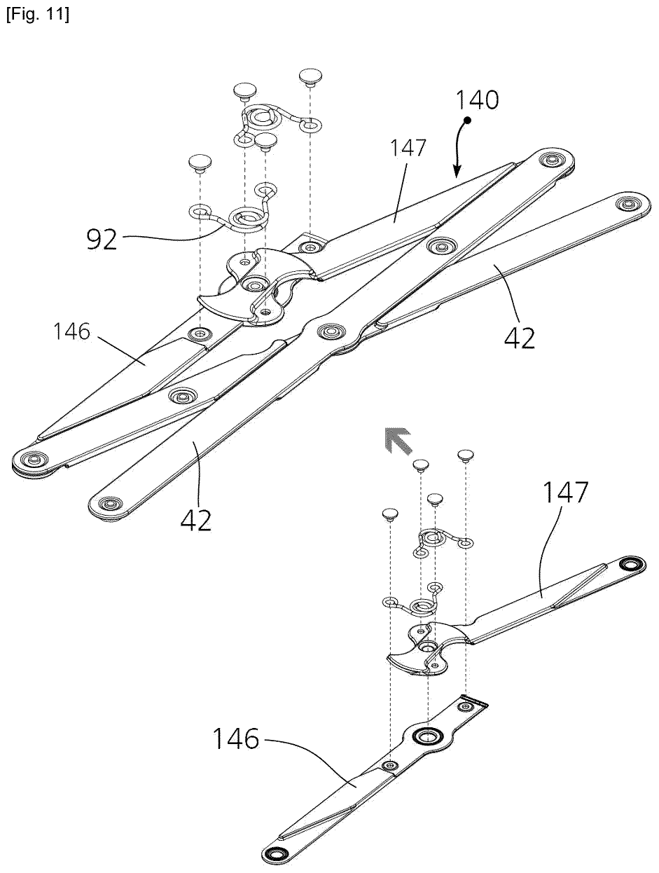

FIG. 11 is a perspective view illustrating a state in which the elastic unit of the sliding controller according to another embodiment of the present invention is being assembled.

Referring to FIG. 11, in the sliding controller 140 according to another embodiment of the present invention, center parts of the two main bars 42 are rotatably connected to each other, ends on one side of the sub bars 146 and 147 are rotatably connected to ends of the main bars 42, and ends on the other side of the sub bars are rotatably connected to each other.

The elastic unit 90 in which a pair of torsion springs 92 are connected is provided in a part in which the sub bars 146 and 147 are connected to each other.

FIG. 12 is a partially enlarged view illustrating a state in which the elastic unit of the sliding controller according to another embodiment of the present invention is operating.

Referring to FIG. 12, a pair of torsion springs 92 of the elastic unit 90 connect the sub bars 146 and 147 such that an elastic force is applied thereto when the sub bars 146 and 147 are folded or unfolded mutually.

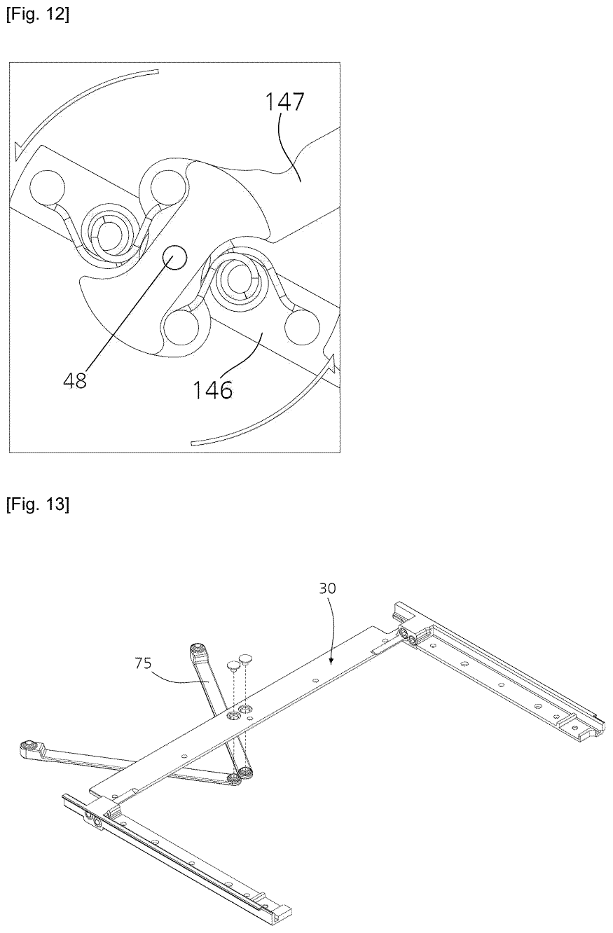

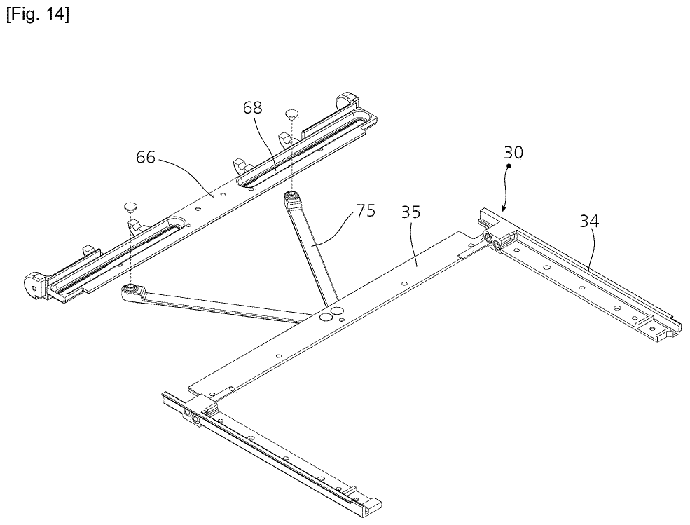

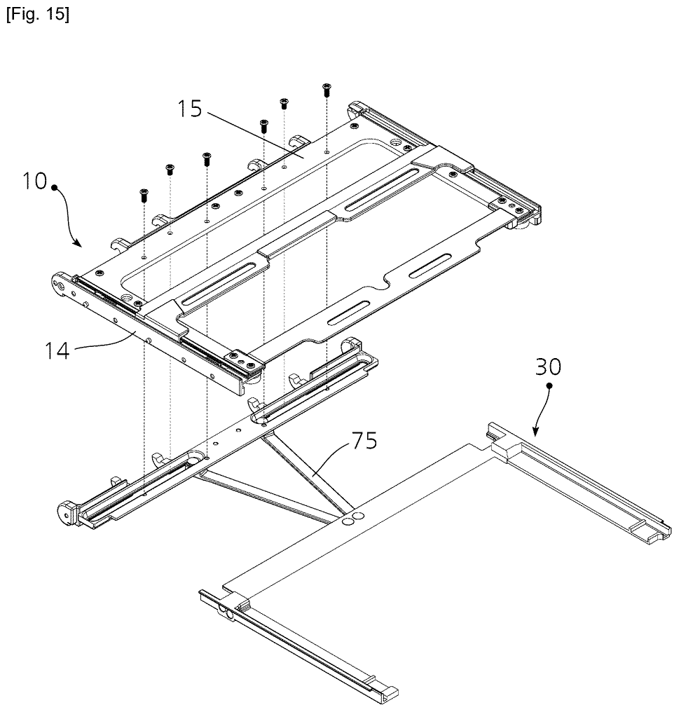

FIG. 13 is a perspective view illustrating a state in which a pair of panel holders are being installed in a front frame of the fixed frame according to the present invention. FIG. 14 is a perspective view illustrating a state in which the panel holders are being installed in a panel holder connection part according to the present invention. FIG. 15 is a perspective view illustrating a state in which the panel holder connection part is being fixed to the sliding frame according to the present invention. FIG. 16 is a perspective view illustrating a state in which the panel holders have been installed in the panel holder connection part installed in the front frame of the fixed frame and the sliding frame according to the present invention.

Referring to FIGS. 13 to 16, ends of a pair of panel holders 75 are connected to the center of a front part 35 of the fixed frame 30 according to the present invention.

Ends on the other side of the panel holders 75 are slidably inserted into two sliding grooves 68 of the panel holder connection part 66 installed below a front part 15 of the sliding frame 10.

A pair of panel holders 75 serves to support a state in which the flexible display panel 4 has been unfolded when the flexible display panel 4 in which a plurality of joints 6 are provided on the bottom surface thereof is sliding and operating.

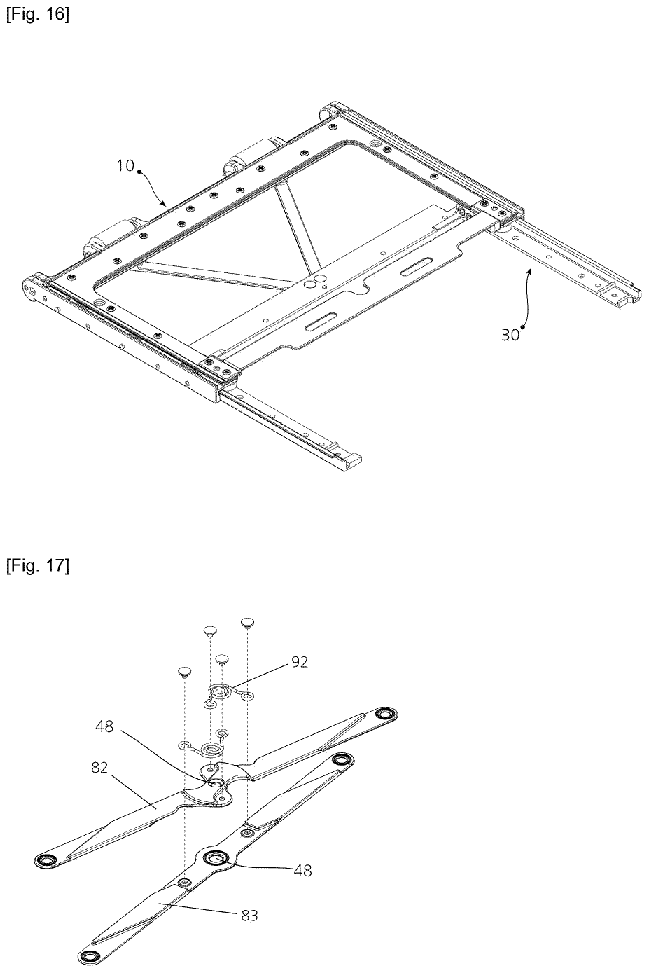

FIG. 17 is a perspective view illustrating a state in which a pair of center bars of a bidirectional sliding controller are being coupled according to the present invention.

Referring to FIG. 17, center parts of a pair of center bars 82 and 83 located at the center of a bidirectional sliding controller 240 are rotatably connected to each other.

The pair of center bars 82 and 83 are connected to each other via a pair of torsion springs 92, and an elastic force is applied when the pair of center bars 82 and 83 are mutually folded or unfolded such that the bidirectional sliding controller 240 is semi-automatically folded or unfolded.

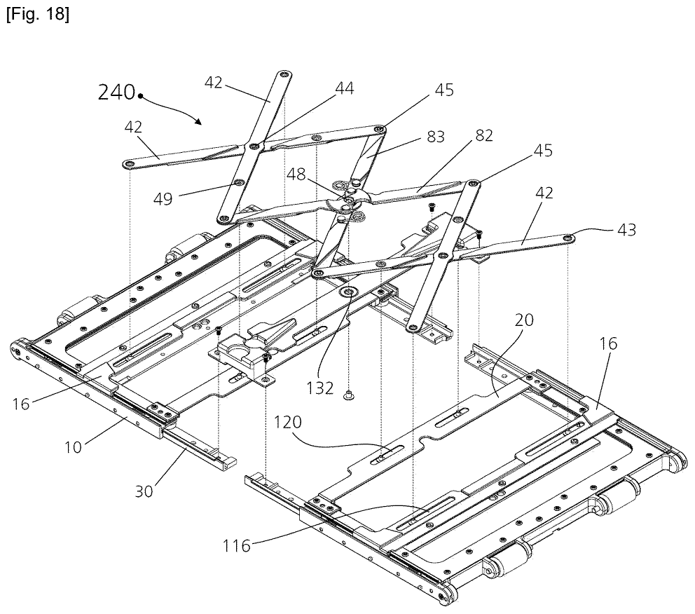

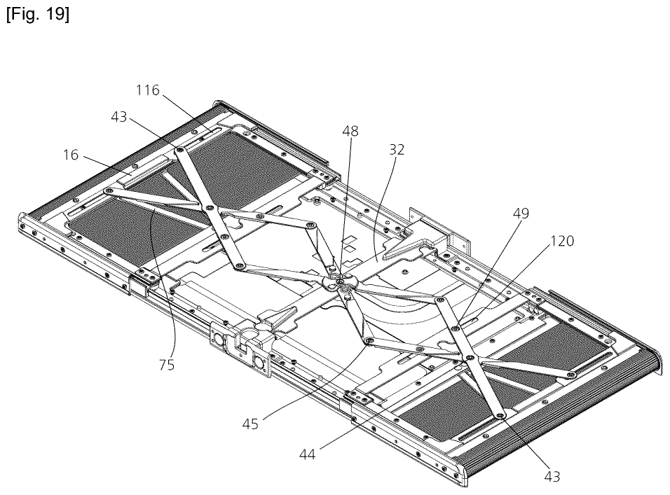

FIG. 18 is a perspective view illustrating a state in which a bidirectional sliding controller for controlling movement of the sliding bars and the sliding frames installed on two sides is being installed according to the present invention. FIG. 19 is a perspective view illustrating a state in which a flexible display panel has been installed in a state in which the bidirectional sliding controller has been assembled into the sliding bars and the sliding frames according to the present invention.

Referring to FIGS. 18 and 19, in a sliding hinge unit for realizing a bidirectional rollable display device in which a display panel slides in two directions at the same time according to another embodiment of the present invention, the bidirectional sliding controller 240 is installed to connect the central bar 32 fixedly connecting two fixed frames 30 to the fixed bars 20 and the sliding bars 16 of two sliding frames 10 in a state in which a pair of fixed frames 30 opposite to each other are connected to each other by the central bar 32 and a pair of sliding frames 10 are slidably installed in the side rails of the pair of fixed frames 30.

The bidirectional sliding controller 240 controls moving distances and speeds of the sliding frames 10 moving along both side rails of the pair of fixed frames 30 and the sliding bars 16 moving along both side rails of the pair of sliding frames 10 together.

In the present invention, the central bar 32 is installed to connect ends of the side rails of the pair of fixed frames 30 to each other.

In the bidirectional sliding controller 240, two pairs of main bars 42 with the same length which are connected in an X-shape (first rotation point 44) and a pair of center bars 82 and 83 which are connected in an X-shape (third rotation point 48) are connected to each other (second rotation point 45).

A pair of main bars 42 are rotatably connected to each other in an X-shape, a pair of center bars 82 and 83 are located at the center of the bidirectional sliding controller 240 in a state in which they are rotatably connected in an X-shape, and ends on one side of the pair of main bars 42 connected in an X-shape are connected to ends of the center bars 82 and 83 (second rotation point 45).

The third rotation point 48 at which a pair of center bars 82 and 83 are connected in an X-shape is connected to the center part 132 of the central bar 32.

A first connection point 43 is formed at the other end of each of the main bars 42. The first connection points 43 are connected to rail grooves 116 formed as grooves in the longitudinal direction of the sliding bar 16 such that the first connection points 43 can slide along the rail grooves 116 of the sliding bar 16.

The first connection points 43 and the rail grooves 116 of the sliding bar 16 are connected by rivets or the like.

A second connection point 49 is formed between the first rotation point 44 and the second rotation point 45 of each main bar 42.

The second connection points 49 of the main bars 42 are connected to rail grooves 120 formed as grooves in the fixed bar 20 of the sliding frame 10 such that the second connection points 49 slide along the rail grooves 120.

The second connection points 49 and the rail grooves 120 are connected by rivets or the like.

The third rotation point 48 at which a pair of sub bars 46 are rotatably connected to each other is rotatably connected to the central point 132 formed at the center of the central bar 32 of the fixed frame 30.

The first connection points 43 and the second connection points 49 of the main bars 42 are connected to the rail grooves 116 of the sliding bar 16 and the fixed bar 20 of the sliding frame 10. The moving distances per unit time of the sliding bar 16 and the sliding frame 10 with respect to the central point 132 of the fixed frame 30 are controlled by the bidirectional sliding controller 240.

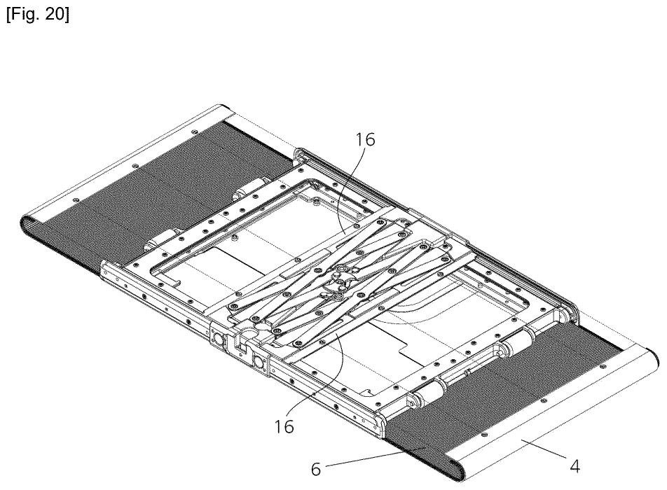

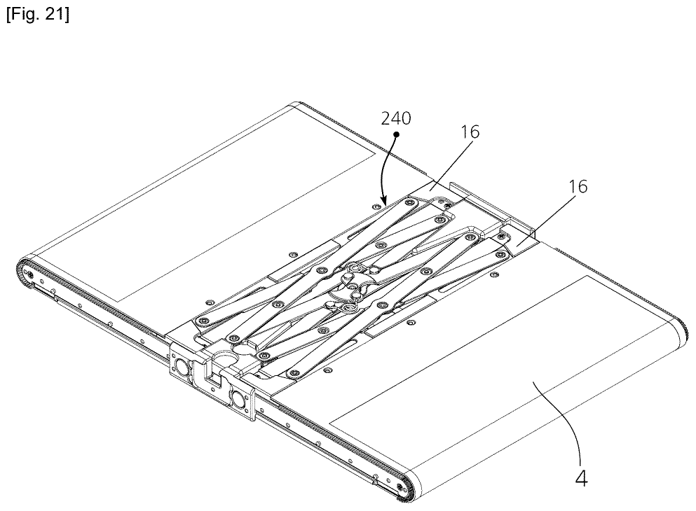

FIG. 20 is a perspective view illustrating a state in which a flexible display panel has been installed in a state in which the bidirectional sliding controller assembled into the sliding bars and the sliding frames has been fully folded according to the present invention. FIG. 21 is a perspective view illustrating a state in which the flexible display panel has been connected to the fully folded bidirectional sliding controller illustrated in FIG. 20.

Referring to FIGS. 20 and 21, in a state in which the bidirectional sliding controller 240 has been fully folded, a part with an invariable size of the flexible display panel 4 is fixed to the top surface of the display device.

Both ends of the flexible display panel 4 are fixed to the sliding bars 16.

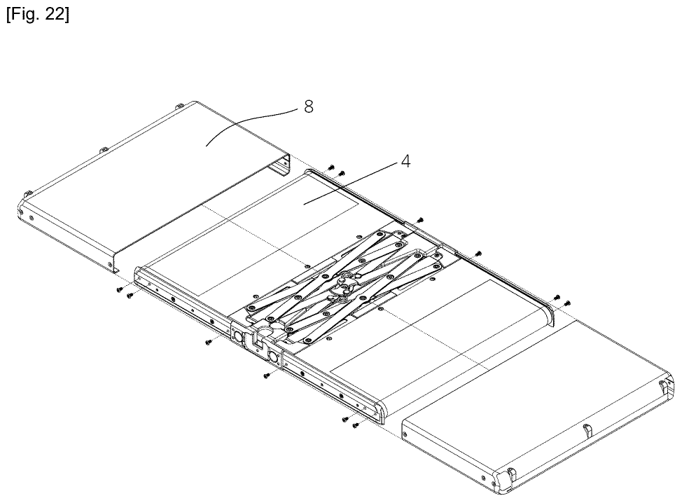

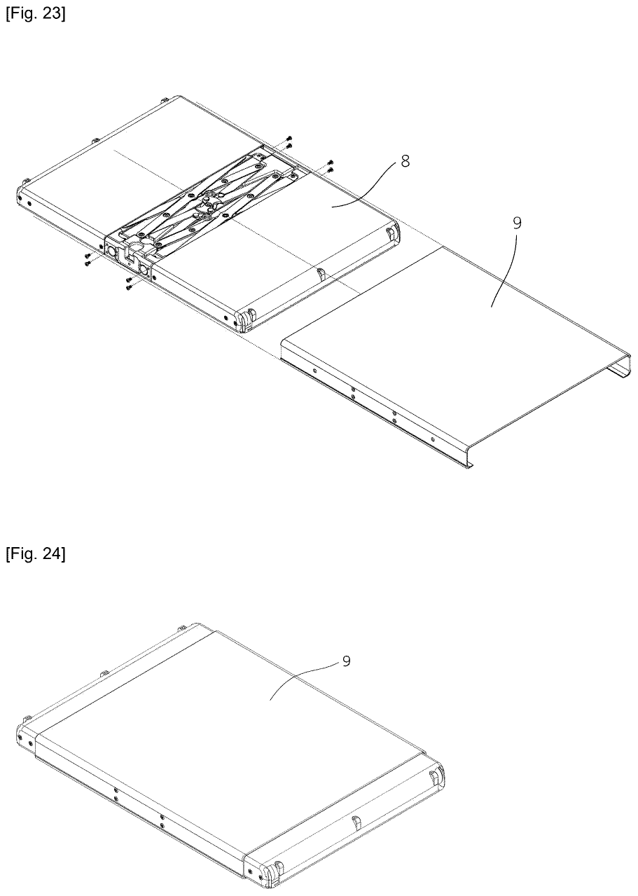

FIG. 22 is a perspective view illustrating a state in which a side surface corresponding to a bottom surface of the display device is being covered by covers in a state in which the flexible display panel has been connected to the fully folded bidirectional sliding controller of the display device according to the present invention. FIG. 23 is a perspective view illustrating a state in which the bidirectional sliding controller exposed from the bottom surface of the display device having variable screen size is being covered by a cover according to the present invention. FIG. 24 is a perspective view illustrating a state in which the bidirectional sliding controller exposed from the bottom surface of the display device having variable screen size has been covered by the cover according to the present invention.

Referring to FIGS. 22 to 24, the flexible display panel 4 exposed from the bottom surface of the display device is covered by partial covers 8, and the whole bottom surface of the display device is covered by a body cover 9.

### INDUSTRIAL APPLICABILITY

While an exemplary embodiment of the invention has been described above using specific terms, such description is only for explanation and it is obvious that the embodiment can be modified in various forms without departing from the technical spirit and scope of the appended claims. Such modified embodiments should not be understood separately from the spirit and scope of the invention and should belong to the appended claims.

1. A display device having variable screen size comprising:
a fixed frame;
a sliding frame that slides along the fixed frame; and
a sliding controller connected to the fixed frame and the sliding frame and configured to control a distance by which the sliding frame slides along the fixed frame,
wherein the sliding controller includes
an X bar in which centers of a pair of main bars are rotatably connected, and
sub bars rotatably connected to ends on one side of the main bars to form a second rotation point, ends on the other side of the sub bars being rotatably connected to a central bar of the fixed frame to form a third rotation point, each sub bar having a length of half the length of the main bars.

2. The display device having variable screen size according to claim 1, wherein the sliding frame includes a sliding bar sliding in the sliding frame and a fixed bar fixed to the sliding frame,
wherein ends on the other side of the main bars of the sliding controller are connected to the sliding bar,
wherein a center part between the first rotation point at which the main bars are connected to each other in an X-shape and the second rotation point is connected to the fixed bar, and
wherein the sliding controller controls moving distances and speeds of the sliding frame moving along both side rails of the fixed frame and the sliding bar moving along the sliding frame together.

3. The display device having variable screen size according to claim 1, wherein elastic devices provided in the sub bars in a state in which the pair of sub bars are connected to the central bar of the fixed frame and are connected to each other at the third rotation point apply an elastic force to the sub bars in opposite directions.

4. The display device having variable screen size according to claim 1, wherein a panel holder for preventing sagging of a flexible display panel is installed between the sliding frame and the fixed frame.

5. A display device having variable screen size comprising:
a pair of fixed frames;
a central bar configured to fixedly connect the pair of fixed frames;
a pair of sliding frames that slide along the fixed frames; and
a bidirectional sliding controller connected to the fixed frames and the sliding frames and configured to control a distance by which the sliding frames slide along the fixed frame with respect to a center part of the central bar,
wherein the bidirectional sliding controller includes center bars of which centers are connected to the central bar in an X-shape, and ends on one side of the center bars connected in an X-shape are connected to the main bars connected in an X-shape to form a second rotation point.

6. The display device having variable screen size according to claim 5, wherein the sliding frame includes a sliding bar sliding in the sliding frame and a fixed bar fixed to the sliding frame,
wherein ends on the other side of the main bars of the bidirectional sliding controller are connected to the sliding bar,
wherein a center part between the first rotation point at which the main bars are connected to each other in an X-shape and the second rotation point is connected to the fixed bar, and
wherein the bidirectional sliding controller controls moving distances and speeds of the sliding frames moving along both side rails of the fixed frames and the sliding bars moving along the sliding frames together.

7. The display device having variable screen size according to claim 5, wherein a center at which the pair of center bars are connected to each other is connected to the central bar of the fixed frame to form a third rotation point, and an elastic device is connected to the center bars such that an elastic force is applied to the center bars in opposite directions.

8. The display device having variable screen size according to claim 5, wherein a panel holder for preventing sagging of a flexible display panel is installed between each sliding frame and the corresponding fixed frame.
